(19) United States
(12) Patent Application Publication
(10) Pub. No.: US 2025/0208422 A1
(43) Pub. Date: Jun. 26, 2025

(54) RETINAL PROJECTION DEVICE

(71) Applicant: TDK Corporation, Tokyo (JP)

(72) Inventors: Takekazu Yamane, Tokyo (JP); Tomohito Mizuno, Tokyo (JP); Hideaki Fukuzawa, Tokyo (JP); Tetsuya Shibata, Tokyo (JP); Takeshi Nojiri, Tokyo (JP)

(73) Assignee: TDK Corporation, Tokyo (JP)

(21) Appl. No.: 18/983,990

(22) Filed: Dec. 17, 2024

(30) Foreign Application Priority Data
Dec. 21, 2023 (JP) 2023-215599

(51) Int. Cl. G02B 27/01; G02B 26/08; G02B 27/30

(52) U.S. Cl. CPC G02B 27/0172; G02B 26/0833; G02B 27/30; G02B 2027/0114; G02B 2027/0178

(57) ABSTRACT

A retinal projection device includes: a light source that emits laser light containing at least one of red light, green light, and blue light; a movable mirror that performs scanning with the laser light; a reflector that projects an image onto a retina of a user wearing a near-eye wearable device by reflecting the laser light having passed through the movable mirror and irradiating the retina with reflected light; and an adjustment unit that is provided between the movable mirror and the reflector, and causes the red light, the green light, and the blue light corresponding to one pixel included in the image to be incident on the reflector at incident angles different from each other such that the red light, the green light, and the blue light corresponding to the one pixel are reflected in a same direction by the reflector.

### CROSS-REFERENCE TO RELATED APPLICATION

This application claims the benefit of priority from Japanese Patent Application No. 2023-215599 filed with the Japan Patent Office on Dec. 21, 2023, the entire contents of which are incorporated herein by reference.

### TECHNICAL FIELD

The present disclosure relates to a retinal projection device.

### BACKGROUND

Near-eye wearable devices such as smart glasses are known. For example, US 2018/0113310 A1 discloses a near eye display assembly including an image source and a combiner including a nanostructured surface optically coupled to the image source, wherein the image information is formed on the nanostructured surface of the combiner to be conveyed within a field of view of a user.

### SUMMARY

In the near-eye display assembly described in US 2018/0113310 A1, the nanostructured surface functions as a reflecting surface. In a reflector such as a mirror formed of such a nanostructure (meta-optics mirror) and a diffractive mirror, the reflection angle of light may change depending on the wavelength of light. Therefore, when an image is projected onto the retina of the user, chromatic aberration may occur.

The present disclosure describes a retinal projection device capable of reducing chromatic aberration.

A retinal projection device according to one aspect of the present disclosure is a device to be mounted on a near-eye wearable device. The retinal projection device includes: a light source that emits laser light containing at least one of red light, green light, and blue light; a movable mirror that performs scanning with the laser light; a reflector that projects an image onto a retina of a user wearing the near-eye wearable device by reflecting the laser light having passed through the movable mirror and irradiating the retina with reflected light; and an adjustment unit that is provided between the movable mirror and the reflector, and causes the red light, the green light, and the blue light corresponding to one pixel included in the image to be incident on the reflector at incident angles different from each other such that the red light, the green light, and the blue light corresponding to the one pixel are reflected in a same direction by the reflector.

In the retinal projection device, the red light, the green light, and the blue light corresponding to one pixel included in the image are incident on the reflector at different incident angles by the adjustment unit so that the red light, the green light, and the blue light are reflected in the same direction by the reflector. Accordingly, since the red light, the green light, and the blue light corresponding to one pixel can be reflected in the same direction, chromatic aberration can be reduced.

In some embodiments, the adjustment unit may include a first spectroscopic device and a second spectroscopic device arranged sequentially along an optical path of the laser light, the first spectroscopic device and the second spectroscopic device in which refraction angles change depending on a wavelength of the laser light. The laser light having passed through the movable mirror may be incident on the first spectroscopic device. The second spectroscopic device may emit the red light, the green light, and the blue light corresponding to the one pixel toward a same position in the reflector. In this case, the laser light containing the red light, the green light, and the blue light is incident on the first spectroscopic device, whereby the traveling directions of the red light, the green light, and the blue light are changed for each of the wavelengths. Accordingly, since the red light, the green light, and the blue light are incident on the second spectroscopic device at different positions in the second spectroscopic device, the red light, the green light, and the blue light are emitted toward the same position in the reflector by the second spectroscopic device, whereby the incident angles at which the red light, the green light, and the blue light are incident on the reflector can be made different from each other.

In some embodiments, each of the first spectroscopic device and the second spectroscopic device may be a metalens including a plurality of nanostructures provided along a surface on which the laser light is incident. By using the metalens, the first spectroscopic device and the second spectroscopic device can be easily realized.

In some embodiments, each of the first spectroscopic device and the second spectroscopic device may be a diffractive lens. By using the diffractive lens, the first spectroscopic device and the second spectroscopic device can be easily realized.

In some embodiments, each of the first spectroscopic device and the second spectroscopic device may be a prism. By using the prism, the first spectroscopic device and the second spectroscopic device can be easily realized.

In some embodiments, the adjustment unit may further include a mirror that is provided between the first spectroscopic device and the second spectroscopic device, and specularly reflects the laser light. In this case, the incident angle at which the laser light is incident on the mirror is equal to the reflection angle at which the laser light is reflected by the mirror. Therefore, the traveling direction of the laser light can be changed without being affected by the wavelength of the laser light. Accordingly, the degree of freedom in the arrangement of the first spectroscopic device and the second spectroscopic device can be increased.

In some embodiments, the adjustment unit may further include a third spectroscopic device that is provided between the first spectroscopic device and the second spectroscopic device, the third spectroscopic device in which a refraction angle changes depending on the wavelength of the laser light. In this case, it becomes easy to adjust the incident angles of the red light, the green light, and the blue light corresponding to one pixel.

In some embodiments, the above-described retinal projection device may further include a collimator that is provided between the light source and the movable mirror, and converts the laser light into parallel light. In this case, since the diffusion of the laser light is suppressed, the incident angles of the red light, the green light, and the blue light can be more reliably adjusted by the adjustment unit.

In some embodiments, the reflector may be a metamirror including a plurality of nanostructures provided along a surface of a lens of the near-eye wearable device facing an eyeball of the user. Even when a metamirror in which the reflection angle of light changes depending on the wavelength of the light is used as a reflector, chromatic aberration can be reduced.

According to each aspect and each embodiment of the present disclosure, chromatic aberration can be reduced.

### BRIEF DESCRIPTION OF THE DRAWINGS

FIG. 1 is a perspective view showing an appearance of a near-eye wearable device including a retinal projection device according to an embodiment.

FIG. 2 is a configuration diagram schematically showing the retinal projection device shown in FIG. 1.

FIG. 3 is a configuration diagram schematically showing the adjustment unit shown in FIG. 2.

FIG. 4 is an enlarged plan view of a unit region of the spectroscopic device shown in FIG. 3.

FIG. 5 is a perspective view schematically showing the nanostructure shown in FIG. 4.

FIG. 6 is a diagram showing the relationship between the diameter of the columnar body and the phase change amount of the transmitted light.

FIG. 7 is a diagram showing the relationship between the position of the spectroscopic device shown in FIG. 4 in the U-axis direction and the phase change amount of the transmitted light.

FIG. 8 is an enlarged view of the reflector shown in FIG. 2.

FIG. 9 is a plan view schematically showing an example of the unit region shown in FIG. 8.

FIG. 10 is a cross-sectional view taken along the line X-X of FIG. 9.

FIG. 11 is a diagram showing the relationship between the length of the metal body and the phase change amount of the reflected light.

FIG. 12 is a diagram showing the relationship between the position of the reflector shown in FIG. 8 in the X-axis direction and the phase change amount of the reflected light.

FIG. 13 is a diagram for explaining the incident angle and the refraction angle in each spectroscopic device and the incident angle and the reflection angle in the reflector.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system and a UVW coordinate system may be shown. The Y-axis direction is a direction intersecting (for example, orthogonal to) the X-axis direction and the Z-axis direction. The Z-axis direction is a direction intersecting (for example, orthogonal to) the X-axis direction and the Y-axis direction. The V-axis direction is a direction intersecting (for example, orthogonal to) the U-axis direction and the W-axis direction. The W-axis direction is a direction intersecting (for example, orthogonal to) the U-axis direction and the V-axis direction.

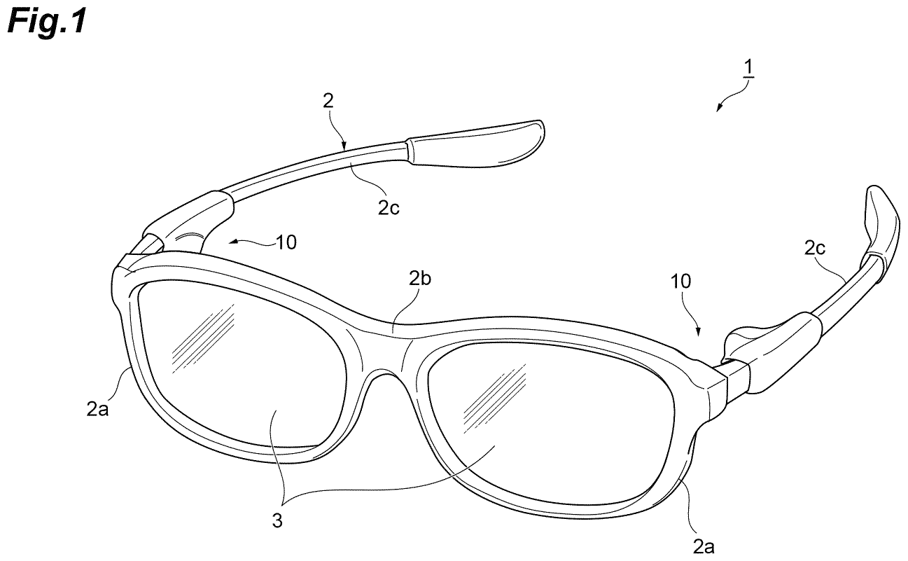

A near-eye wearable device including a retinal projection device according to an embodiment will be described with reference to FIG. 1. FIG. 1 is a perspective view showing an appearance of a near-eye wearable device including a retinal projection device according to an embodiment. The near-eye wearable device 1 shown in FIG. 1 is a device for superimposing an image on the field of view of the real world. The near-eye wearable device 1 is, for example, a head-mounted device, and may take the form of an eyeglass type, a goggle type, a hat type, a helmet type, or the like. Examples of the near-eye wearable device 1 include smart glasses such as augmented reality (AR) glasses, and mixed reality (MR) glasses. The near-eye wearable device 1 includes a frame 2, a lens 3, and a retinal projection device 10.

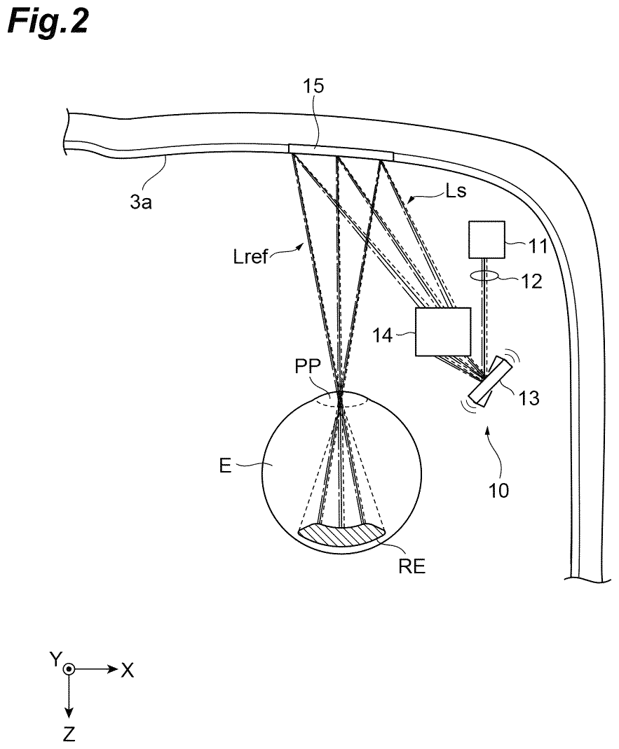

The frame 2 includes a pair of rims 2a, a bridge 2b, and a pair of temples 2c. The rim 2a is a part for holding the lens 3. The bridge 2b is a part connecting the pair of rims 2a. The temple 2c extends from the rim 2a and is a part to be put on an ear of a user. The frame 2 may be a rimless frame. The lens 3 has an inner surface 3a (refer to FIG. 2) facing an eyeball E (refer to FIG. 2) of a user wearing the near-eye wearable device 1.

In the present embodiment, the retinal projection device 10 is a device for directly projecting (drawing) an image onto a retina RE (refer to FIG. 2) of a user wearing the near-eye wearable device 1. The retinal projection device 10 is mounted on the near-eye wearable device 1. In the present embodiment, the near-eye wearable device 1 includes two retinal projection devices 10 in order to project an image onto both the right and left retinas RE, but may include only one of the retinal projection devices 10.

Next, the retinal projection device 10 will be described in detail with reference to FIG. 2. FIG. 2 is a configuration diagram schematically showing the retinal projection device shown in FIG. 1. As shown in FIG. 2, the retinal projection device 10 includes a light source unit 11 (light source), a collimator lens 12 (collimator), a movable mirror 13, an adjustment unit 14, and a reflector 15.

The light source unit 11 emits laser light. As the light source unit 11, for example, a full-color laser module is used. The light source unit 11 includes a red laser diode, a green laser diode, a blue laser diode, and a multiplexer that multiplexes laser lights emitted from laser diodes into one laser light. The light source unit 11 emits the multiplexed laser light. The multiplexed laser light contains at least one of light having a wavelength of red (red light Lr), light having a wavelength of green (green light Lg), and light having a wavelength of blue (blue light Lb). In the following description, the red light Lr, the green light Lg, and the blue light Lb may be rephrased as “visible light”, and the red light Lr, the green light Lg, and the blue light Lb may be collectively referred to as “laser light Ls”. The light source unit 11 emits laser light having a color and intensity corresponding to the pixel of the image to be projected onto the retina RE.

The collimator lens 12 is an optical component for converting the laser light emitted from the light source unit 11 into parallel light. The collimator lens 12 is provided between the light source unit 11 and the movable mirror 13.

The movable mirror 13 is an optical component for performing scanning with the laser light Ls. The movable mirror 13 is provided in a direction in which the laser light converted into the parallel light by the collimator lens 12 is emitted. The movable mirror 13 is configured to be swingable about an axis extending in the horizontal direction (X-axis direction) of the lens 3 and about an axis extending in the vertical direction (Y-axis direction) of the lens 3, for example, and reflects the laser light while changing the angle in the X-axis direction and the Y-axis direction. As the movable mirror 13, for example, a micro electro mechanical systems (MEMS) mirror is used.

The adjustment unit 14 is a device for causing the red light Lr, the green light Lg, and the blue light Lb corresponding to one pixel included in an image to be incident on the reflector 15 at incident angles different from each other so that the red light Lr, the green light Lg, and the blue light Lb corresponding to the pixel are reflected in a same direction by the reflector 15. The adjustment unit 14 is provided between the movable mirror 13 and the reflector 15. Details of the adjustment unit 14 will be described later.

The reflector 15 is an optical component that projects an image onto the retina RE of the user wearing the near-eye wearable device 1 by reflecting the laser light Ls having passed through the movable mirror 13 and irradiating the retina RE with reflected light Lref. No image is displayed on the reflector 15. The reflector 15 is provided on the inner surface 3a of the lens 3. The reflector 15 is a metamirror including a plurality of nanostructures provided along the inner surface 3a. The metamirror is also referred to as a meta-optics mirror. Details of the reflector 15 will be described later.

Although not shown, the retinal projection device 10 further includes a laser driver for driving the light source unit 11, a mirror driver for driving the movable mirror 13, and a controller for controlling the laser driver and the mirror driver.

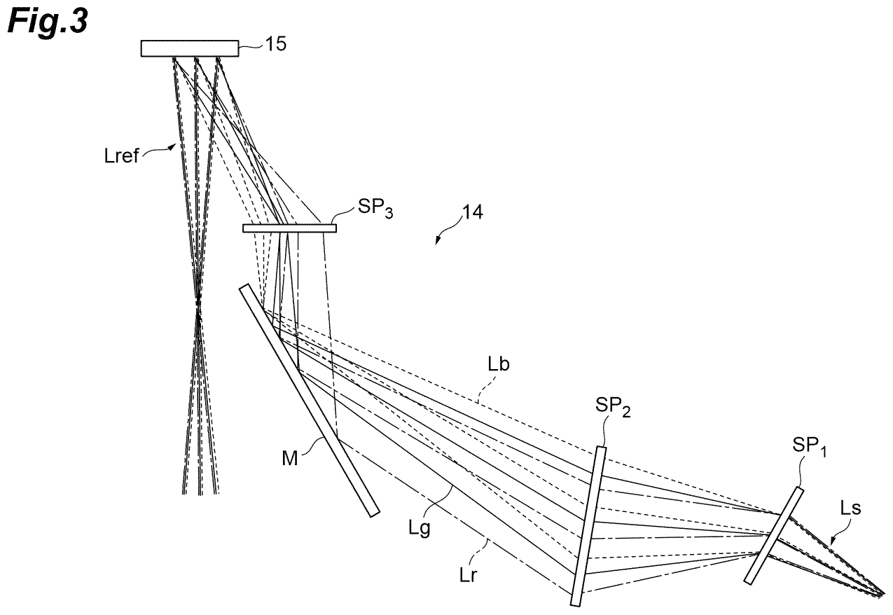

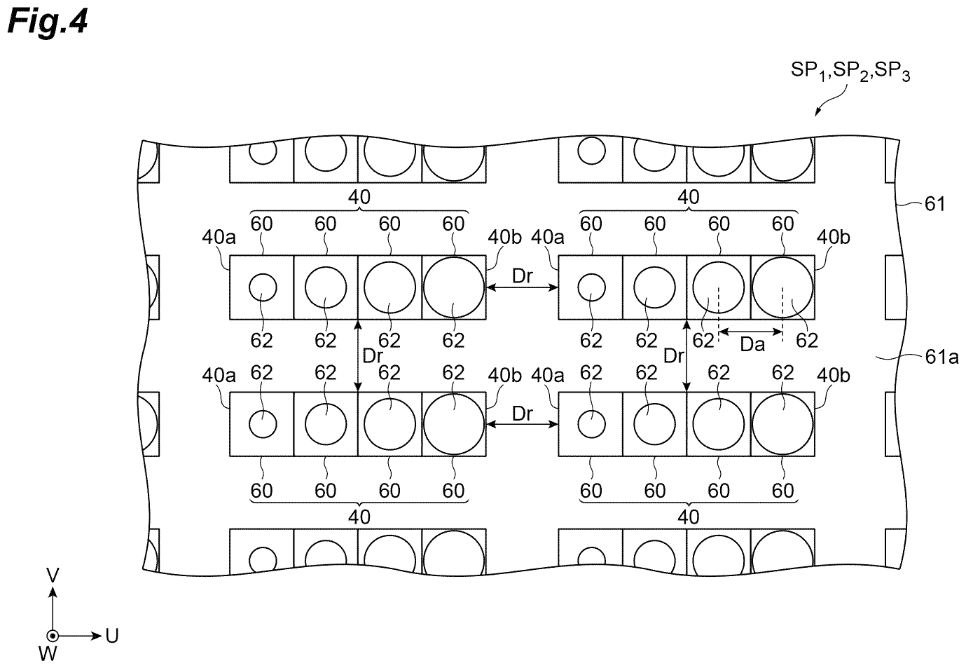

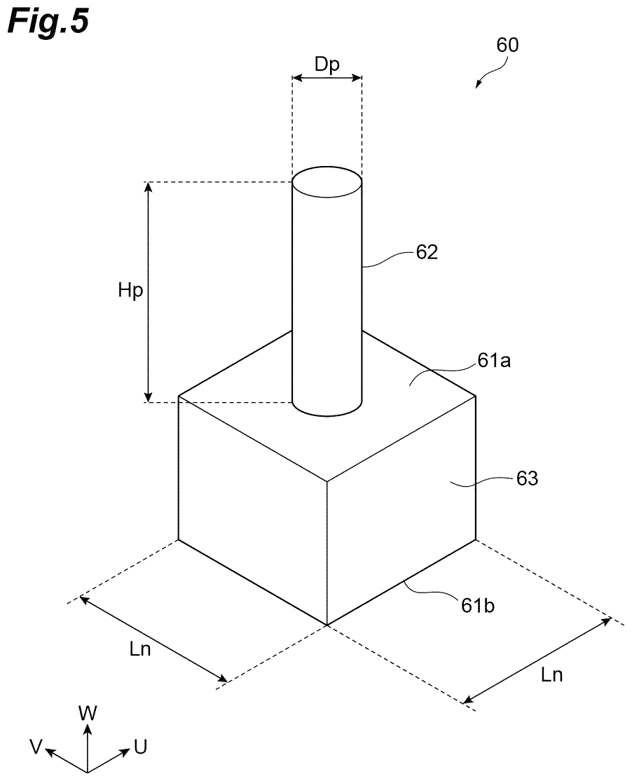

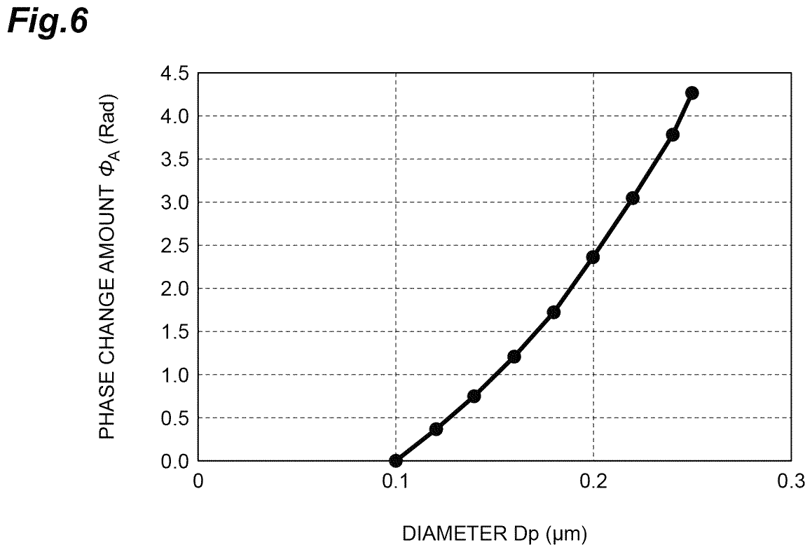

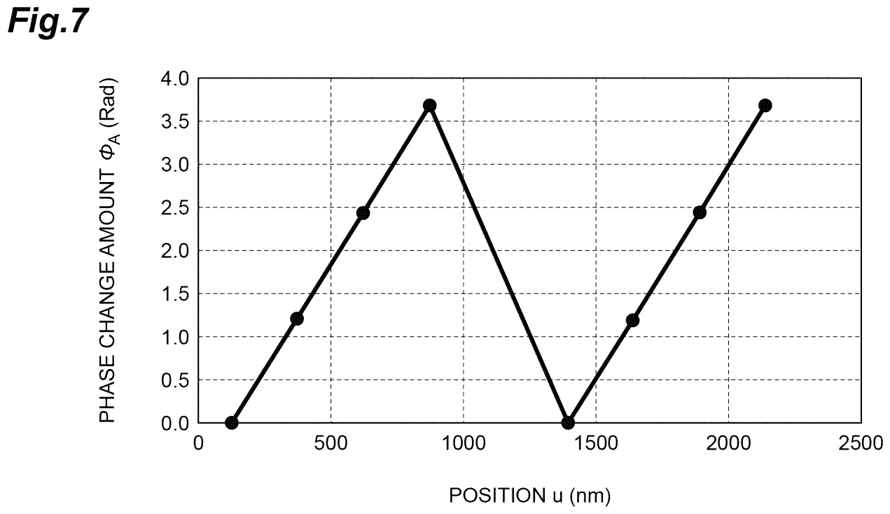

Next, the adjustment unit 14 will be described in detail with reference to FIGS. 3 to 7. FIG. 3 is a configuration diagram schematically showing the adjustment unit shown in FIG. 2. FIG. 4 is an enlarged plan view of a unit region of the spectroscopic device shown in FIG. 3. FIG. 5 is a perspective view schematically showing the nanostructure shown in FIG. 4. FIG. 6 is a diagram showing the relationship between the diameter of the columnar body and the phase change amount of the transmitted light. FIG. 7 is a diagram showing the relationship between the position of the spectroscopic device shown in FIG. 4 in the U-axis direction and the phase change amount of the transmitted light.

As shown in FIG. 3, the adjustment unit 14 includes a spectroscopic device SP₁ (first spectroscopic device), a spectroscopic device SP₂ (third spectroscopic device), a spectroscopic device SP₃ (second spectroscopic device), and a mirror M. The spectroscopic device SP₁, the spectroscopic device SP₂, the mirror M, and the spectroscopic device SP₃ are arranged in that order along the optical path of the laser light Ls.

The mirror M is an optical device that specularly reflects (mirror reflection) each visible light included in the laser light Ls. The mirror M is, for example, a total reflection mirror. The mirror M is provided between the spectroscopic device SP₂ and the spectroscopic device SP₃ in the optical path of the laser light Ls.

Each of the spectroscopic devices SP₁, SP₂, and SP₃ is an optical device in which the refraction angles change depending on the wavelength of the laser light Ls (visible light). In the present embodiment, each of the spectroscopic devices SP₁, SP₂, and SP₃ is a metalens. A metalens is also referred to as a metasurface lens. The laser light Ls having passed through the movable mirror 13 is incident on the spectroscopic device SP₁. The spectroscopic device SP₃ emits the red light Lr, the green light Lg, and the blue light Lb corresponding to one pixel toward the same position in the reflector 15. The spectroscopic devices SP₁, SP₂, and SP₃ are arranged such that the normal to the incident surface of the spectroscopic device SP₁, the normal to the incident surface of the spectroscopic device SP₂, and the normal to the incident surface of the spectroscopic device SP₃ intersect each other. The incident surface is a surface on which the laser light Ls (visible light) is incident.

As shown in FIG. 4, each spectroscopic device includes a plurality of unit regions 40. The plurality of unit regions 40 are arranged in a two-dimensional array along the incident surface of the spectroscopic device. The two adjacent unit regions 40 are arranged with a predetermined interval Dr therebetween. The UVW coordinate system shown in FIGS. 4 and 5 is set for each spectroscopic device, and is effective only within the corresponding spectroscopic device.

As shown in FIGS. 4 and 5, each spectroscopic device includes a substrate 61 and a plurality of columnar bodies 62. The substrate 61 is a substrate having visible light transparency through which visible light passes. That is, the substrate 61 is a transparent substrate. As the constituent material of the substrate 61, a material having visible light transparency and having a refractive index higher than 1 is used. Examples of such constituent materials include silicon oxide (e.g., SiO₂), titanium oxide (e.g., TiO₂), silicon nitride (e.g., SiN), and titanium nitride (e.g., TiN). The substrate 61 has a surface 61a and a surface 61b. The surfaces 61a and 61b are main surfaces that intersect with the incident direction of the laser light Ls. The thickness of the substrate 61 (the distance between the surface 61a and the surface 61b) is, for example, 0.1 mm to 5 mm.

Each columnar body 62 is a columnar member having visible light transparency through which visible light passes. Each columnar body 62 has, for example, a cylindrical shape. The shape of each columnar body 62 is not limited to a cylindrical shape, and may be a rectangular column, or may be a truncated cone shape or a truncated pyramid shape with a tapered tip. As a constituent material of the columnar body 62, similarly to the substrate 61, a material having visible light transparency and having a refractive index higher than 1 is used. The refractive index of the columnar body 62 is higher than 1.

Each columnar body 62 is erected on the surface 61a. The length (height Hp) of the columnar body 62 in the direction intersecting (orthogonal to) the surface 61a is, for example, 0.1 μm to 10 μm. The diameter Dp of the columnar body 62 is, for example, 100 nm to 250 nm. The height Hp and the diameter Dp of the columnar body 62 are determined so as to obtain a desired refraction angle for each visible light. A method for determining the height Hp and the diameter Dp of the columnar body 62 will be described later.

A plurality of columnar bodies 62 are provided for each unit region 40, and the plurality of columnar bodies 62 included in one unit region 40 are arranged in one direction (U-axis direction). The central axes of the plurality of columnar bodies 62 included in one unit region 40 are arranged substantially in a straight line. The interval Da between the central axes of any two columnar bodies 62 adjacent to each other included in one unit region 40 is substantially constant. No columnar bodies 62 are provided in regions other than the unit region 40.

Each unit region 40 is divided into a plurality of nanostructures 60 arranged in the U-axis direction. Each nanostructure 60 includes one columnar body 62 and a base 63. The base 63 is a part of the substrate 61 and is a rectangular parallelepiped portion having a rectangle (square) outline centered on the central axis of the columnar body 62 in a plan view, with a side length Ln. When the visible light passes through the nanostructure body 60, a phase delay in accordance with the height Hp and the diameter Dp of the columnar body 62 occurs. In the present embodiment, the heights Hp of all the columnar bodies 62 included in the spectroscopic device are set to the same height, and the phase delay is adjusted by the diameter Dp.

For example, when silicon dioxide (SiO₂) is used as the constituent material of the columnar bodies 62 and the base 63, the length Ln is 250 nm, and the height Hp is 1.5 μm, the relationship shown in FIG. 6 is obtained by determining the phase change amount φ_{A} (phase delay amount) in the single nanostructure body 60 including the columnar body 62 having a diameter Dp while changing the diameter Dp. The horizontal axis in FIG. 6 indicates the diameter Dp (unit: μm), and the vertical axis in FIG. 6 indicates the phase change amount φ_{A} (unit: radian).

The phase change amount (φ_{A} is an amount by which the phase of the transmitted light from the phase of the transmitted light in the nanostructure body 60 including the columnar body 62 having a certain diameter Dp changes when the diameter Dp of the columnar body 62 is changed. In the example shown in FIG. 6, assuming that the phase of the transmitted light in the nanostructure body 60 including the columnar body 62 having the diameter Dp of 0.1 μm is 0 radian, the phase change amount φ_{A} of the transmitted light when the diameter Dp is changed is shown. As shown in FIG. 6, as the diameter Dp increases, the phase change amount φ_{A} of the transmitted light after passing through the nanostructure 60 increases.

As shown in FIG. 7, the diameters Dp of the plurality of columnar bodies 62 included in one unit region 40 are set so that the phase change amount φ_{A} of the transmitted light by the nanostructure bodies 60 (columnar bodies 62) increases or decreases linearly from one end 40a to the other end 40b in the U-axis direction of the unit region 40. The horizontal axis in FIG. 7 indicates the position u (unit: μm) in the U-axis direction, and the vertical axis in FIG. 7 indicates the phase change amount φ_{A} (unit: radian). Further, in one unit region 40, the phase change amount φ_{A} of the transmitted light substantially changes by 360° (2π radian) from one end 40a to the other end 40b.

In other words, the diameters Dp of the plurality of columnar bodies 62 included in one unit region 40 are set so as to satisfy the following conditions: the phase gradient dφ_{A}/du, which is the gradient of the phase change amount φ_{A} at the position u, becomes a desired value; and the phase change amount φ_{A} of the transmitted light changes substantially by 360° (2π radian) from one end 40a to the other end 40b is satisfied.

For example, in order to obtain a phase gradient dφ_{A}/du of 4.93 radian/μm, two adjacent unit regions 40 are arranged at an interval Dr of 273 nm, and in each unit region 40, a columnar body 62 having a diameter Dp of 100 nm, a columnar body 62 having a diameter Dp of 160 nm, a columnar body 62 having a diameter Dp of 206 nm, and a columnar body 62 having a diameter Dp of 235 nm are arranged sequentially from one end 40a toward the other end 40b at intervals Da of 250 nm. A method for determining the phase gradient dφ_{A}/du will be described later.

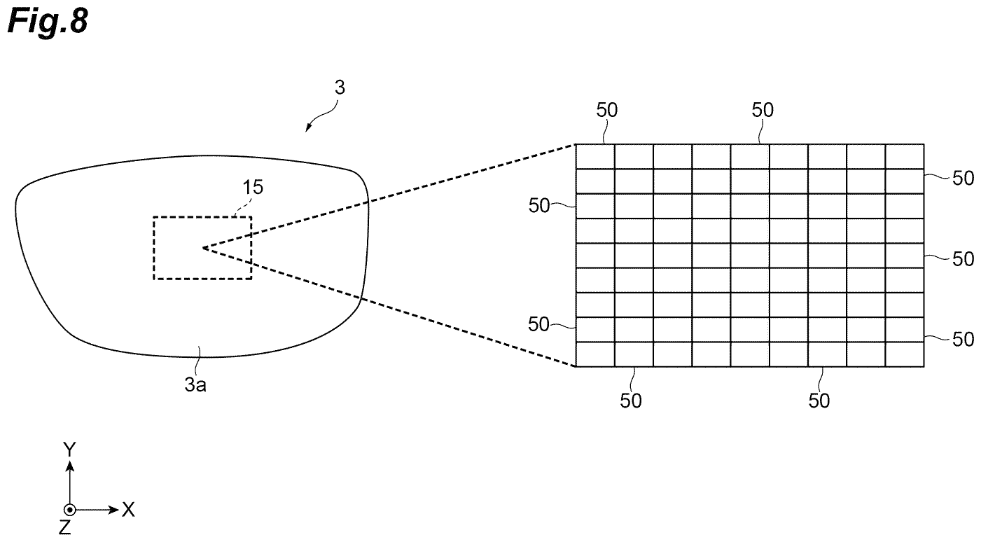

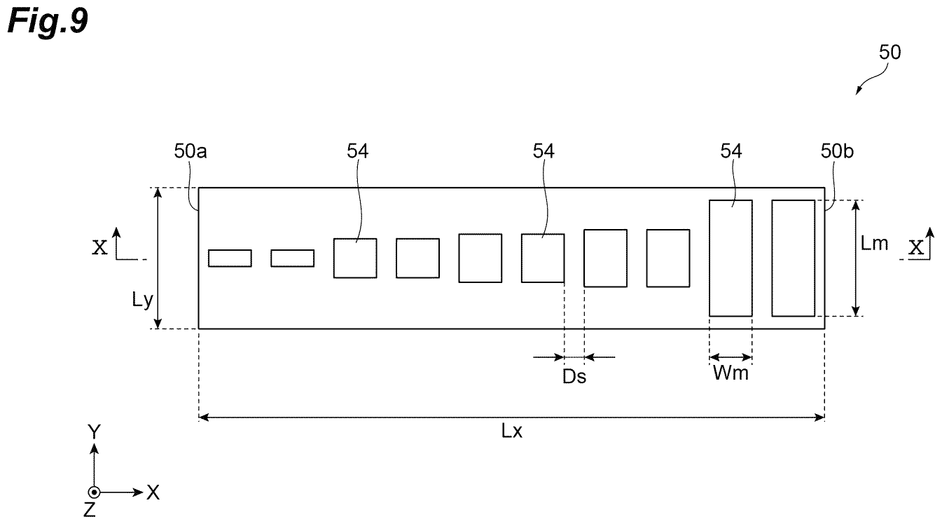

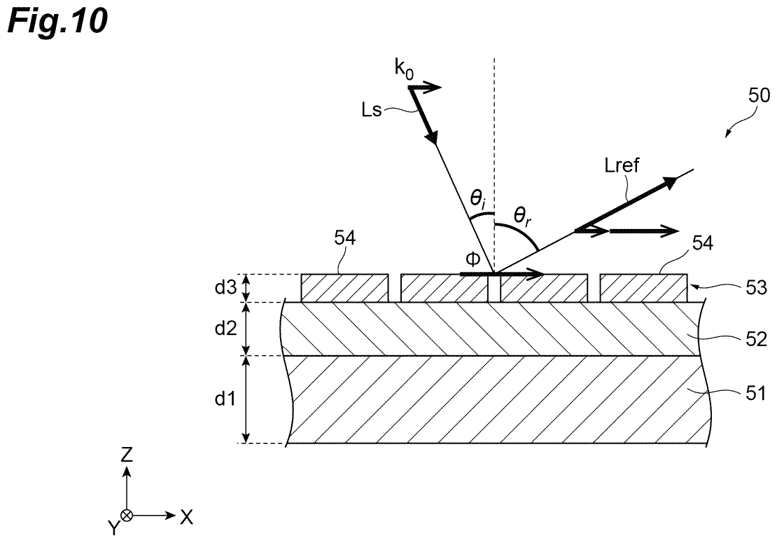

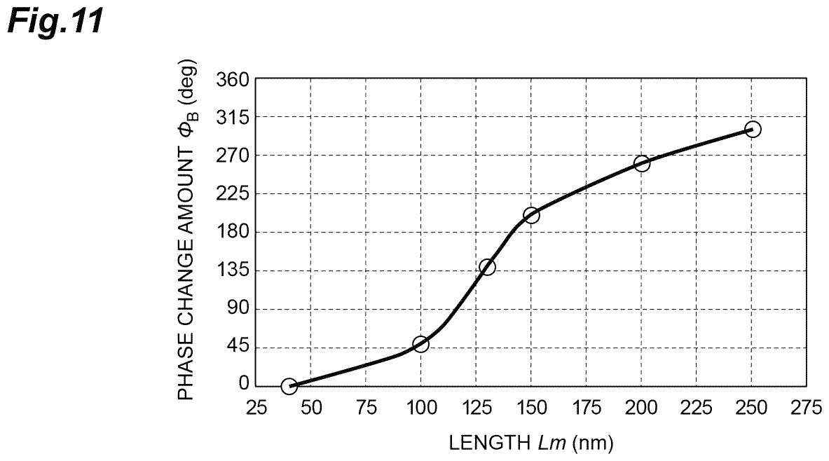

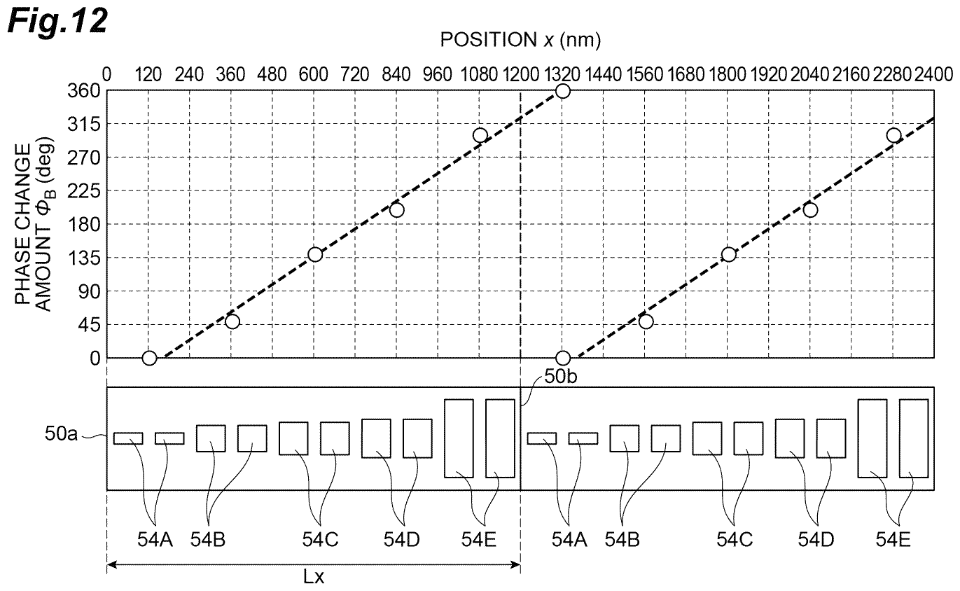

Next, the configuration of the reflector 15 will be described with reference to FIGS. 8 to 12. FIG. 8 is an enlarged view of the reflector shown in FIG. 2. FIG. 9 is a plan view schematically showing an example of the unit region shown in FIG. 8. FIG. 10 is a cross-sectional view taken along the line X-X of FIG. 9. FIG. 11 is a diagram showing the relationship between the length of the metal body and the phase change amount of the reflected light. FIG. 12 is a diagram showing the relationship between the position of the reflector shown in FIG. 8 in the X-axis direction and the phase change amount of the reflected light.

As shown in FIG. 8, the reflector 15 is divided into a plurality of unit regions 50. The plurality of unit regions 50 are provided along the inner surface 3a of the lens 3. The plurality of unit regions 50 are arranged in a two-dimensional array in the horizontal direction (X-axis direction) and the vertical direction (Y-axis direction) of the lens 3. Each unit region 50 is a nanostructure body configured so as to reflect the laser light Ls at a reflection angle θᵣ corresponding to a position where the unit region 50 is provided when the laser light Ls is incident on the unit region 50. The reflection angle θᵣ of each unit region 50 is set so that the laser light Ls (reflected light Lref) reflected by each unit region 50 passes through the center of the pupil PP.

As shown in FIGS. 9 and 10, the reflector 15 sequentially includes, in the Z-axis direction, a metal layer 51, a dielectric layer 52, and a metal layer 53.

The metal layer 51 is a base layer. The metal layer 51 is provided on the inner surface 3a of the lens 3. The metal layer 51 is made of a metal having high reflection characteristics in the visible light region. The metal layer 51 is made of, for example, a metal containing at least one element selected from the group consisting of gold (Au), copper (Cu), silver (Ag), iridium (Ir), ruthenium (Ru), rhodium (Rh), titanium (Ti), tantalum (Ta), tungsten (W), cobalt (Co), iron (Fe), and nickel (Ni). The length (thickness d1) of the metal layer 51 in the Z-axis direction may be any length as long as the metal layer 51 is capable of passing a resonance current and reflecting light. The thickness d1 is, for example, 1 nm to 1000 nm. Hereinafter, the length in the Z-axis direction may be referred to as “thickness”.

The dielectric layer 52 is a layer functioning as a spacer. The dielectric layer 52 is provided between the metal layer 51 and the metal layer 53 in the Z-axis direction. In the present embodiment, the dielectric layer 52 is provided on the metal layer 51. The dielectric layer 52 has a dielectric constant that does not interfere with the electromagnetic action of the metal layer 51 and the metal layer 53. The dielectric layer 52 is made of a material that is transparent in the visible light region. The dielectric layer 52 may be made of a material having a high dielectric constant in order to achieve high reflection characteristics. The dielectric layer 52 is made of, for example, one compound selected from the group consisting of silicon oxide (e.g., SiO₂), titanium oxide (e.g., TiO₂), magnesium oxide (e.g., MgO), and aluminum oxide (e.g., Al₂O₃). The thickness d2 of the dielectric layer 52 is, for example, 1 nm to 1000 nm.

The metal layer 53 is a layer for exciting electromagnetic resonance together with the metal layer 51. The metal layer 51 and the metal layer 53 are stacked in the Z-axis direction with the dielectric layer 52 interposed therebetween. In the present embodiment, the metal layer 53 is provided on the dielectric layer 52. The metal layer 53 is made of a metal having high reflection characteristics in the visible light region. Similar to the metal layer 51, the metal layer 53 is made of, for example, a metal containing at least one element selected from the group consisting of gold (Au), copper (Cu), silver (Ag), iridium (Ir), ruthenium (Ru), rhodium (Rh), titanium (Ti), tantalum (Ta), tungsten (W), cobalt (Co), iron (Fe), and nickel (Ni).

The metal layer 53 includes a plurality of metal bodies 54 arranged in the X-axis direction. The thickness d3 of each metal body 54 is, for example, 1 nm to 1000 nm. The length (width Wm) of each metal body 54 in the X-axis direction is about 100 nm. The length Lm of each metal body 54 in the Y-axis direction is determined in accordance with the reflection angle θᵣ. The interval Ds between two metal bodies 54 adjacent to each other in the X-axis direction is set so that the wave front of the reflected light becomes continuous. The interval Ds may have any size as long as the two metal bodies 54 do not come into contact with each other, and is set to, for example, half or less of the wavelength of the incident light (laser light Ls). The interval Ds is, for example, about 20 nm. The plurality of metal bodies 54 is formed by photolithography, for example.

When the visible light is reflected by the metal body 54, a phase delay in accordance with the width Wm and the length Lm of the metal body 54 occurs. In the present embodiment, the widths Wm of all the metal bodies 54 included in the reflector 15 are set to the same width, and the phase delay is adjusted by the length Lm. For example, when gold (Au) is used as the constituent material of the metal layer 51 and the metal body 54, silicon dioxide (SiO₂) is used as the constituent material of the dielectric layer 52, the thickness d1 is 200 nm, the thickness d2 is 50 nm, the thickness d3 is 40 nm, and the width Wm is 100 nm, the relationship shown in FIG. 11 is obtained by obtaining the phase change amount φ_{B} (phase delay amount) of the single metal body 54 having each length Lm. The horizontal axis in FIG. 11 indicates the length Lm (unit: nm), and the vertical axis in FIG. 11 indicates the phase change amount φ_{B} (unit: °.

The phase change amount φ_{B} is an amount by which the phase of the reflected light Lref from the phase of the reflected light Lref by the metal body 54 having a certain length Lm changes when the length Lm is changed. In the example shown in FIG. 11, assuming that the phase of the reflected light Lref by the metal body 54 having the length Lm of 40 nm is 0°, the phase change amount φ_{B} of the reflected light Lref when the length Lm is changed is shown. As shown in FIG. 11, as the length Lm increases, the phase change amount (φ_{B} of the reflected light Lref increases.

For example, in the metal body 54 having a length Lm of 40 nm (hereinafter referred to as a “metal body 54A”), the phase change amount (φ_{B} is 00. In the metal body 54 having a length Lm of 100 nm (hereinafter referred to as a “metal body 54B”), the phase change amount φ_{B} is 50°. In the metal body 54 having a length Lm of 130 nm (hereinafter referred to as a “metal body 54C”), the phase change amount (φ_{B} is 1400. In the metal body 54 having a length Lm of 150 nm (hereinafter referred to as a “metal body 54D”), the phase change amount φ_{B} is 2000. In the metal body 54 having a length Lm of 250 nm (hereinafter referred to as a “metal body 54E”), the phase change amount φ_{B} is 3000.

As shown in FIG. 12, the lengths Lm of the plurality of metal bodies 54 included in one unit region 50 are set so that the phase change amount φ_{B} of the reflected light Lref by the metal bodies 54 increases or decreases linearly from one end 50a to the other end 50b of the unit region 50. The horizontal axis in FIG. 12 indicates the position x (unit: nm) in the X-axis direction, and the vertical axis in FIG. 12 indicates the phase change amount φ_{B} (unit: °). Further, in one unit region 50, the phase change amount φ_{B} of the reflected light Lref substantially changes by 360° (2π radian) from one end 50a to the other end 50b.

In other words, in a unit region 50 having a desired length Lx, the lengths Lm of the plurality of metal bodies 54 included in one unit region 50 are set so as to satisfy the following conditions: the phase change amount φ_{B} of the reflected light Lref by the metal bodies 54 increases or decreases linearly from one end 50a toward the other end 50b; and the phase change amount φ_{B} of the reflected light Lref changes substantially by 360° (2π radian) from one end 50a to the other end 50b.

The number and lengths Lm of the metal bodies 54 included in the unit region 50 may be determined by selecting some metal bodies 54 from the above-described metal bodies 54 in accordance with the length Lx and arranging the selected metal bodies 54 in the X-axis direction so as to satisfy the above-described condition. A plurality of sets of two metal bodies 54 having the same length Lm may be arranged in the X-axis direction. For example, as shown in FIG. 12, when the length Lx is 1200 nm, the metal body 54A, the metal body 54A, the metal body 54B, the metal body 54B, the metal body 54C, the metal body 54C, the metal body 54D, the metal body 54D, the metal body 54E, and the metal body 54E are arranged sequentially from one end 50a to the other end 50b at intervals Ds of 20 nm in the X-axis direction. A method for determining the length Lx will be described later.

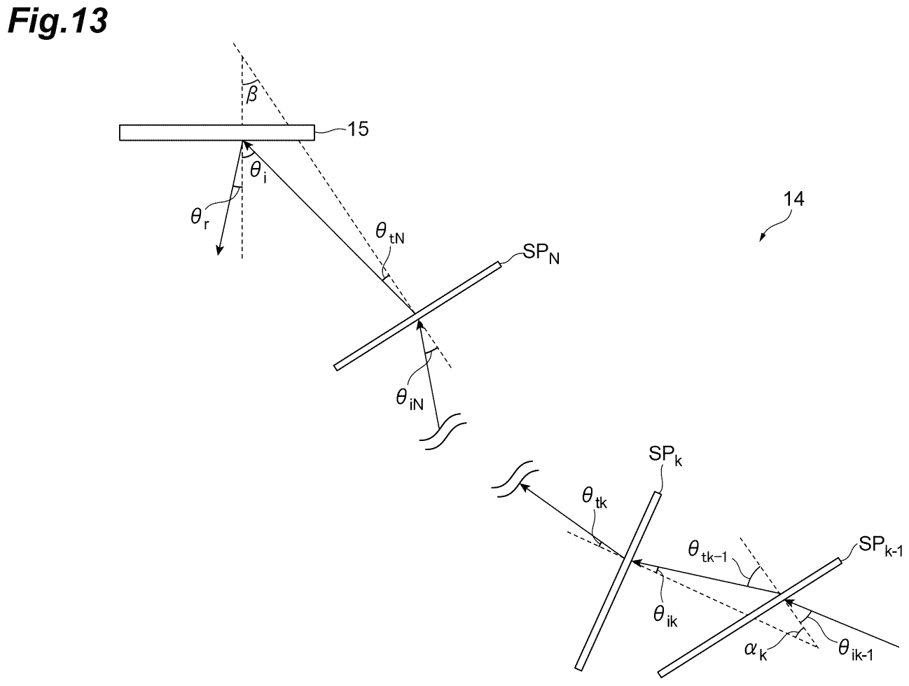

Next, a method for determining the phase gradient dφ_{A}/du and the length Lx will be described with reference to FIG. 13. FIG. 13 is a diagram for explaining the incident angle and the refraction angle in each spectroscopic device and the incident angle and the reflection angle in the reflector. In FIG. 13, a method for determining the phase gradient dφ_{A}/du and the length Lx in a case where the adjustment unit 14 is generalized to include N spectroscopic devices SPₖ (k is an integer of 1 to N) will be described. FIG. 3 shows an example in which N=3.

First, the operating principle of each spectroscopic device will be described. In the k-th spectroscopic device SPₖ (hereinafter, simply referred to as “spectroscopic device SPₖ”), since the laser light Ls is transmitted with the phase change amount φ_{Ak} that changes in accordance with the position u in the U-axis direction, a wave front is formed by interference between the transmitted lights. That is, a plane wave having the phase gradient dφ_{Ak}/du as a wave vector is generated. Here, according to the generalized Snell's law, Equation (1) is established.

$$\begin{matrix}[ Equation 1 ] & \\ {n}_{t} \times sin {θ}_{tk} - {n}_{i} \times sin {θ}_{ik} = \frac{λ}{2 π} \times \frac{d {φ}_{Ak}}{du} & ( 1 )\end{matrix}$$

As shown in FIG. 13, the incident angle θᵢₖ is an angle formed between the normal to the incident surface of the spectroscopic device SPₖ and the incident direction of the laser light Ls. The refraction angle θₜₖ is an angle formed between the normal to the incident surface of the spectroscopic device SPₖ and the emission direction of the transmitted light. Here, the incident angle θ₁ₖ and the refraction angle θₜₖ are expressed as positive values in the counterclockwise direction from the normal and as negative values in the clockwise direction from the normal. The refractive index nᵢ is the refractive index of the surrounding medium on the incident side of the spectroscopic device SPₖ. The refractive index nₜ is the refractive index of the surrounding medium on the transmission side of the spectroscopic device SPₖ. To simplify the description, it is assumed that the phase gradient dφ_{Ak}/du does not depend on the wavelength λ. Assuming that the refractive index nᵢ and the refractive index nₜ are 1, Equation (2) is obtained from Equation (1).

$$\begin{matrix}[ Equation 2 ] & \\ sin {θ}_{t k} = sin {θ}_{i k} + \frac{λ}{2 π} x \frac{d {φ}_{A k}}{d u} & ( 2 )\end{matrix}$$

The wavelength λ_{red} of the red light Lr, the wavelength λ_{green} of the green light Lg, and the wavelength λ_{blue} of the blue light Lb are different from each other, and in the spectroscopic device SPₖ, the positions on which the red light Lr, the green light Lg, and the blue light Lb are incident may be different from each other. Accordingly, by substituting the wavelength λ_{red} and the phase gradient dφ_{Ak_red}/du at the position where the red light Lr is incident in the spectroscopic device SPₖ into Equation (2), Equation (3) representing the relationship between the incident angle θ_{ik_red} and the refraction angle θ_{tk_red} of the red light Lr in the spectroscopic device SPₖ is obtained.

$$\begin{matrix}[ Equation 3 ] & \\ sin {θ}_{tk \_ red} = sin {θ}_{ik \_ red} + \frac{{λ}_{red}}{2 π} \times \frac{d {φ}_{Ak \_ red}}{du} & ( 3 )\end{matrix}$$

By substituting the wavelength λ_{green} and the phase gradient dφ_{Ak_green}/du at the position where the green light Lg is incident in the spectroscopic device SPₖ into Equation (2), Equation (4) representing the relationship between the incident angle θ_{ik_green} and the refraction angle θ_{tk_green} of the green light Lg in the spectroscopic device SPₖ is obtained.

$$\begin{matrix}[ Equation 4 ] & \\ sin {θ}_{tk \_ green} = sin {θ}_{ik \_ green} + \frac{{λ}_{green}}{2 π} \times \frac{d {φ}_{Ak \_ green}}{du} & ( 4 )\end{matrix}$$

By substituting the wavelength λ_{blue} and the phase gradient dφ_{Ak_blue}/du at the position where the blue light Lb is incident in the spectroscopic device SPₖ into Equation (2), Equation (5) representing the relationship between the incident angle θ_{ik_blue} and the refraction angle θ_{tk_blue} of the blue light Lb in the spectroscopic device SPₖ is obtained.

$$\begin{matrix}[ Equation 5 ] & \\ sin {θ}_{tk \_ blue} = sin {θ}_{ik \_ blue} + \frac{{λ}_{blue}}{2 π} \times \frac{d {φ}_{Ak \_ blue}}{du} & ( 5 )\end{matrix}$$

The incident angle of each color light in the spectroscopic device SPₖ is an angle obtained by subtracting the angle αₖ from the refraction angle θₜₖ₋₁ of the k-1th spectroscopic device SPₖ₋₁ (hereinafter simply referred to as “spectroscopic device SPₖ₋₁”). The angle αₖ is an angle formed between the normal to the incident surface of the spectroscopic device SPₖ₋₁ and the normal to the incident surface of the spectroscopic device SPₖ. Here, the angle αₖ is expressed as a positive value in the counterclockwise direction from the normal to the incident surface of the spectroscopic device SPₖ₋₁ and a negative value in the clockwise direction from the normal to the incident surface of the spectroscopic device SPₖ₋₁. Accordingly, Equation (6) is obtained by expressing the incident angle θ_{ik_red} in Equation (3) using the refraction angle θtk-1_red and the angle αₖ.

$$\begin{matrix}[ Equation 6 ] & \\ sin {θ}_{tk \_ red} = sin ( {θ}_{tk - 1 \_ red} - {α}_{k} ) + \frac{{λ}_{red}}{2 π} \times \frac{d {φ}_{Ak \_ red}}{du} & ( 6 )\end{matrix}$$

Equation (7) is obtained by expressing the incident angle θ_{ik_green} in Equation (4) using the refraction angle θ_{tk-1_green} and the angle αₖ.

$$\begin{matrix}[ Equation 7 ] & \\ sin {θ}_{tk \_ green} = sin ( {θ}_{tk - 1 \_ green} - {α}_{k} ) + \frac{{λ}_{green}}{2 π} \times \frac{d {φ}_{Ak \_ green}}{du} & ( 7 )\end{matrix}$$

Equation (8) is obtained by expressing the incident angle θ_{ik_blue} in Equation (5) using the refraction angle θ_{tk-1_blue} and the angle αₖ.

$$\begin{matrix}[ Equation 8 ] & \\ sin {θ}_{tk \_ blue} = sin ( {θ}_{tk - 1 \_ blue} - {α}_{k} ) + \frac{{λ}_{blue}}{2 π} \times \frac{d {φ}_{Ak \_ blue}}{du} & ( 8 )\end{matrix}$$

The refraction angle θ_{t0_red} is equal to the incident angle θ_{i1_red}, the refraction angle θ_{t0_green} is equal to the incident angle θ_{i1_green}, and the refraction angle θ_{t0_blue} is equal to the incident angle θ_{i1_blue}. The angle α₁ is 0°.

Since the laser light Ls obtained by multiplexing the red light Lr, the green light Lg, and the blue light Lb is incident on the first spectroscopic device SP₁, the incident angle θ_{i1_red}, the incident angle θ_{i1_green}, and the incident angle θ_{i1_blue} are equal to each other as shown in Equation (9), and the phase gradient dφ_{A1_red}/du, the phase gradient dφ_{A1_green}/du, and the phase gradient dφ_{A1_blue}/du are equal to each other as shown in Equation (10).

$$\begin{matrix}[ Equation 9 ] & \\ sin {θ}_{i 1 \_ red} = sin {θ}_{i 1 \_ green} = sin {θ}_{i 1 \_ blue} = sin {θ}_{i 1} & ( 9 )\end{matrix}$$

$$\begin{matrix}[ Equation 10 ] & \\ \frac{d {φ}_{A 1 \_ red}}{d u} = \frac{d {φ}_{A 1 \_ green}}{d u} = \frac{d {φ}_{A 1 \_ blue}}{d u} = \frac{d {φ}_{A 1}}{d u} & ( 10 )\end{matrix}$$

Next, the operating principle of the reflector 15 will be described. In the reflector 15, since the laser light Ls (visible light) is reflected with the phase change amount φ_{B} that changes in accordance with the position x in the X-axis direction, the wave front is formed by the interference between the reflected lights. That is, a plane wave having the phase gradient dφ_{B}/dx as the wave vector Φ is generated. Here, as shown in FIG. 10, according to the generalized Snell's law, Equation (11) is established.

$$\begin{matrix}[ Equation 11 ] & \\ {k}_{0} \times sin {θ}_{i} + Φ = {k}_{0} \times sin {θ}_{r} & ( 11 )\end{matrix}$$

The incident angle θᵢ is an angle formed between the normal to the reflecting surface of the reflector 15 and an incident direction of the laser light Ls. The reflection angle θᵣ is an angle formed between the normal to the reflecting surface of the reflector 15 and an emission direction of the reflected light Lref. In the plane including the laser light Ls and the reflected light Lref, when the reflected light Lref is emitted on the side opposite to the incident light (laser light Ls) with the normal line as a boundary, the reflection angle θᵣ is expressed by a positive value, and when the reflected light Lref is emitted on the same side as the incident light (laser light Ls) with the normal line as a boundary, the reflection angle θᵣ is expressed by a negative value.

The wave vector k₀ is expressed by 2π/λ using the wavelength λ of the laser light Ls. The wave vector Φ is expressed by 2π/Lx using the length Lx of the unit region 50 in the X-axis direction. By transforming Equation (11) using these relations, Equation (12) is obtained.

$$\begin{matrix}[ Equation 12 ] & \\ sin {θ}_{r} = sin {θ}_{i} + \frac{λ}{L x} & ( 12 )\end{matrix}$$

The red light Lr, the green light Lg, and the blue light Lb constituting the same pixel are incident on the same position in the reflector 15 at different incident angles, and are reflected at the same reflection angle. The relationship between the incident angle θ_{i_red} and the reflection angle θ_{r_red} of the red light Lr in the reflector 15 is expressed by Equation (13) using the wavelength λ_{red} and the length Lx.

$$\begin{matrix}[ Equation 13 ] & \\ sin {θ}_{r \_ red} = sin {θ}_{i \_ red} + \frac{{λ}_{red}}{Lx} & ( 13 )\end{matrix}$$

The relationship between the incident angle θ_{i_green} and the reflection angle θ_{r_green} of the green light Lg in the reflector 15 is expressed by Equation (14) using the wavelength λ_{green} and the length Lx.

$$\begin{matrix}[ Equation 14 ] & \\ sin {θ}_{r \_ green} = sin {θ}_{i \_ green} + \frac{{λ}_{green}}{Lx} & ( 14 )\end{matrix}$$

The relationship between the incident angle θ_{i_blue} and the reflection angle θ_{r_blue} of the blue light Lb in the reflector 15 is expressed by Equation (15) using the wavelength λ_{blue} and the length Lx.

$$\begin{matrix}[ Equation 15 ] & \\ sin {θ}_{r \_ blue} = sin {θ}_{i \_ blue} + \frac{{λ}_{blue}}{Lx} & ( 15 )\end{matrix}$$

The incident angle of the light of each color on the reflector 15 is an angle obtained by adding the refraction angle in the N-th spectroscopic device SP_{N} to the angle β. The angle β is an angle formed between the normal to the incident surface of the N-th spectroscopic device SP_{N} and the normal to the reflecting surface of the reflector 15. Accordingly, Equations (13) to (15) are transformed into Equations (16) to (18), respectively.

$$\begin{matrix}[ Equation 16 ] & \\ sin {θ}_{r \_ red} = sin ( β + {θ}_{tN \_ red} ) + \frac{{λ}_{red}}{Lx} & ( 16 )\end{matrix}$$

$$\begin{matrix}[ Equation 17 ] & \\ sin {θ}_{r \_ green} = sin ( β + {θ}_{tN \_ green} ) + \frac{{λ}_{green}}{Lx} & ( 17 )\end{matrix}$$

$$\begin{matrix}[ Equation 18 ] & \\ sin {θ}_{r \_ blue} = sin ( β + {θ}_{tN \_ blue} ) + \frac{{λ}_{blue}}{Lx} & ( 18 )\end{matrix}$$

As described above, the reflection angle θ_{r_red}, the reflection angle θ_{r_green}, and the reflection angle θ_{r_blue} are reflection angles θᵣ equal to each other, and the reflection angle θᵣ is determined in advance in accordance with the position where the unit region 50 is provided, so that Equation (19) is established.

$$\begin{matrix}[ Equation 19 ] & \\ sin ( β + {θ}_{t {N}_{r e d}} ) + \frac{{λ}_{red}}{Lx} = sin ( β + {θ}_{{tN}_{green}} ) + \frac{{λ}_{green}}{Lx} = sin ( β + {θ}_{{tN}_{blue}} ) + \frac{{λ}_{blue}}{Lx} = sin {θ}_{r} & ( 19 )\end{matrix}$$

The angle αₖ, the angle β, the phase gradient dφ_{Ak_red}/du, the phase gradient dφ_{Ak_green}/du, the phase gradient dφ_{Ak_blue}/du, and the length Lx are determined so that Equation (19) is satisfied under the conditions of Equations (9) and (10). The number of the spectroscopic devices SPₖ may be adjusted so as to obtain a solution satisfying the above conditions, and one or a plurality of mirrors M may be provided in the optical path as necessary.

For example, in the case where the mirror M is provided between the spectroscopic device SPₖ₋₁ and the spectroscopic device SPₖ, the incident angle θᵢₖ is an angle obtained by subtracting the refraction angle θₜₖ₋₁ from the angle γ₁, and then subtracting this result from the angle γ₂. The angle γ₁ is an angle formed between the normal to the incident surface of the spectroscopic device SPₖ₋₁ and the normal to the reflecting surface of the mirror M. The angle γ₂ is an angle formed between the normal to the incident surface of the spectroscopic device SPₖ and the normal to the reflecting surface of the mirror M.

In the example shown in FIG. 3, the angle α₁ is set to 20°, the angle γ₁ is set to 39°, the angle γ₂ is set to 61°, and the angle β is set to 0°. Assuming that the incident angle θᵢ₁ of the laser light Ls corresponding to the pixel at the right end is −10°, the incident angle θᵢ₁ of the laser light Ls corresponding to the pixel at the center is 0°, and the incident angle θᵢ₁ of the laser light Ls corresponding to the pixel at the left end is +10°, the reflection angle θ_{r_red}, the reflection angle θ_{r_green}, and the reflection angle θ_{r_blue} become equal to each other by setting the respective parameters to the values shown in Table 1. The wavelength λ_{red} was set to 650 nm, the wavelength λ_{green} was set to 550 nm, and the wavelength λ_{blue} was set to 450 nm, and then each parameter was calculated.

TABLE 1

| | Left End | | | Center | | | Right End | | |
|---|---|---|---|---|---|---|---|---|---|
| | Red | Green | Blue | Red | Green | Blue | Red | Green | Blue |
| dφ_{A1}/du | 4.93 | 4.93 | 4.93 | 4.93 | 4.93 | 4.93 | 5.27 | 5.27 | 5.27 |
| [rad/μm] | | | | | | | | | |
| dφ_{A2}/du | 9.68 | 8.54 | 8.20 | 5.27 | 5.27 | 5.27 | 3.04 | 2.52 | 1.60 |
| [rad/μm] | | | | | | | | | |
| dφ_{A3}/du | 5.78 | 5.13 | 4.15 | 5.27 | 5.27 | 5.27 | 5.53 | 4.91 | 4.53 |
| [rad/μm] | | | | | | | | | |
| 2π/Lx | 7.14 | 7.14 | 7.14 | 4.88 | 4.88 | 4.88 | 4.22 | 4.22 | 4.22 |
| [rad/μm] | | | | | | | | | |

In the retinal projection device 10 described above, the red light Lr, the green light Lg, and the blue light Lb corresponding to one pixel included in the image are incident on the reflector 15 at different incident angles by the adjustment unit 14 so that the red light Lr, the green light Lg, and the blue light Lb are reflected in the same direction by the reflector 15. Accordingly, since the red light Lr, the green light Lg, and the blue light Lb corresponding to one pixel can be reflected in the same direction by the reflector 15, the chromatic aberration can be reduced.

In the adjustment unit 14, the spectroscopic device SP₁, the spectroscopic device SP₂, and the spectroscopic device SP₃ are arranged sequentially along the optical path of the laser light Ls. The laser light Ls containing the red light Lr, the green light Lg, and the blue light Lb is incident on the spectroscopic device SP₁, whereby the traveling directions of the red light Lr, the green light Lg, and the blue light Lb are changed for each wavelength, and then the traveling direction of each visible light is finely adjusted by the spectroscopic device SP₂. Accordingly, since the red light Lr, the green light Lg, and the blue light Lb are incident on the spectroscopic device SP₃ at different positions in the spectroscopic device SP₃, the red light Lr, the green light Lg, and the blue light Lb are emitted toward the same position in the reflector 15 by the spectroscopic device SP₃, whereby the incident angles at which the red light Lr, the green light Lg, and the blue light Lb are incident on the reflector 15 can be made different from each other.

By providing the spectroscopic device SP₂ between the spectroscopic device SP₁ and the spectroscopic device SP₃, it becomes easy to adjust the incident angles of the red light Lr, the green light Lg, and the blue light Lb.

In the adjustment unit 14, the mirror M is provided between the spectroscopic device SP₂ and the spectroscopic device SP₃. The incident angle at which the laser light Ls (visible light) is incident on the mirror M is equal to the reflection angle at which the laser light Ls (visible light) is reflected by the mirror M. Therefore, the traveling direction of the laser light Ls (visible light) can be changed without being affected by the wavelength of the laser light Ls (visible light). Accordingly, the degree of freedom in the arrangement of the spectroscopic devices SP₁, SP₂, and SP₃ can be increased.

Each spectroscopic device is a metalens including a plurality of nanostructures 60 provided along an incident surface of the spectroscopic device. By using the metalens, the spectroscopic device can be easily realized.

The collimator lens 12 is provided between the light source unit 11 and the movable mirror 13. Accordingly, since the diffusion of the laser light Ls is suppressed, the incident angles of the red light Lr, the green light Lg, and the blue light Lb can be more reliably adjusted by the adjustment unit 14.

Since the reflector 15 is a metamirror, the reflection angle of light changes depending on the wavelength of light. According to the retinal projection device 10, even when a metamirror is used as the reflector 15, chromatic aberration can be reduced.

The retinal projection device according to the present disclosure is not limited to the above-described embodiments.

The retinal projection device 10 is not required to include the collimator lens 12.

The adjustment unit 14 is not required to include the mirror M as long as the adjustment unit 14 includes two or more spectroscopic devices SPₖ.

Each spectroscopic device SPₖ may be a diffractive lens. By using the diffractive lens, the spectroscopic device SPₖ can be easily realized.

Each spectroscopic device SPₖ may be a prism. By using the prism, the spectroscopic device SPₖ can be easily realized.

The reflector 15 is not limited to a metamirror as long as the reflector 15 is a reflector in which the reflection angle of light changes depending on the wavelength of light.

### ADDITIONAL STATEMENTS

### Clause 1

A retinal projection device to be mounted on a near-eye wearable device, the retinal projection device comprising:
a light source configured to emit laser light containing at least one of red light, green light, and blue light;
a movable mirror configured to perform scanning with the laser light;
a reflector configured to project an image onto a retina of a user wearing the near-eye wearable device by reflecting the laser light having passed through the movable mirror and irradiating the retina with reflected light; and
an adjustment unit provided between the movable mirror and the reflector, the adjustment unit configured to cause the red light, the green light, and the blue light corresponding to one pixel included in the image to be incident on the reflector at incident angles different from each other such that the red light, the green light, and the blue light corresponding to the one pixel are reflected in a same direction by the reflector.

### Clause 2

The retinal projection device according to clause 1,
wherein the adjustment unit includes a first spectroscopic device and a second spectroscopic device arranged sequentially along an optical path of the laser light, the first spectroscopic device and the second spectroscopic device in which refraction angles change depending on a wavelength of the laser light,
wherein the laser light having passed through the movable mirror is incident on the first spectroscopic device, and
wherein the second spectroscopic device emits the red light, the green light, and the blue light corresponding to the one pixel toward a same position in the reflector.

### Clause 3

The retinal projection device according to clause 2,
wherein each of the first spectroscopic device and the second spectroscopic device is a metalens including a plurality of nanostructures provided along a surface on which the laser light is incident.

### Clause 4

The retinal projection device according to clause 2,
wherein each of the first spectroscopic device and the second spectroscopic device is a diffractive lens.

### Clause 5

The retinal projection device according to clause 2,
wherein each of the first spectroscopic device and the second spectroscopic device is a prism.

### Clause 6

The retinal projection device according to any one of clauses 2 to 5,
wherein the adjustment unit further includes a mirror provided between the first spectroscopic device and the second spectroscopic device, the mirror configured to specularly reflect the laser light.

### Clause 7

The retinal projection device according to any one of clauses 2 to 6,
wherein the adjustment unit further includes a third spectroscopic device provided between the first spectroscopic device and the second spectroscopic device, the third spectroscopic device in which a refraction angle changes depending on the wavelength of the laser light.

### Clause 8

The retinal projection device according to any one of clauses 1 to 7, further comprising a collimator provided between the light source and the movable mirror, the collimator configured to convert the laser light into parallel light.

### Clause 9

The retinal projection device according to any one of clauses 1 to 8,
wherein the reflector is a metamirror including a plurality of nanostructures provided along a surface of a lens of the near-eye wearable device facing an eyeball of the user.

What is claimed is:

1. A retinal projection device to be mounted on a near-eye wearable device, the retinal projection device comprising:
a light source configured to emit laser light containing at least one of red light, green light, and blue light;
a movable mirror configured to perform scanning with the laser light;
a reflector configured to project an image onto a retina of a user wearing the near-eye wearable device by reflecting the laser light having passed through the movable mirror and irradiating the retina with reflected light; and
an adjustment unit provided between the movable mirror and the reflector, the adjustment unit configured to cause the red light, the green light, and the blue light corresponding to one pixel included in the image to be incident on the reflector at incident angles different from each other such that the red light, the green light, and the blue light corresponding to the one pixel are reflected in a same direction by the reflector.

2. The retinal projection device according to claim 1,
wherein the adjustment unit includes a first spectroscopic device and a second spectroscopic device arranged sequentially along an optical path of the laser light, the first spectroscopic device and the second spectroscopic device in which refraction angles change depending on a wavelength of the laser light,
wherein the laser light having passed through the movable mirror is incident on the first spectroscopic device, and
wherein the second spectroscopic device emits the red light, the green light, and the blue light corresponding to the one pixel toward a same position in the reflector.

3. The retinal projection device according to claim 2,
wherein each of the first spectroscopic device and the second spectroscopic device is a metalens including a plurality of nanostructures provided along a surface on which the laser light is incident.

4. The retinal projection device according to claim 2,
wherein each of the first spectroscopic device and the second spectroscopic device is a diffractive lens.

5. The retinal projection device according to claim 2,
wherein each of the first spectroscopic device and the second spectroscopic device is a prism.

6. The retinal projection device according to claim 2,
wherein the adjustment unit further includes a mirror provided between the first spectroscopic device and the second spectroscopic device, the mirror configured to specularly reflect the laser light.

7. The retinal projection device according to claim 2,
wherein the adjustment unit further includes a third spectroscopic device provided between the first spectroscopic device and the second spectroscopic device, the third spectroscopic device in which a refraction angle changes depending on the wavelength of the laser light.

8. The retinal projection device according to claim 1, further comprising a collimator provided between the light source and the movable mirror, the collimator configured to convert the laser light into parallel light.

9. The retinal projection device according to claim 1,
wherein the reflector is a metamirror including a plurality of nanostructures provided along a surface of a lens of the near-eye wearable device facing an eyeball of the user.
